(19) United States
(12) Patent Application Publication
(10) Pub. No.: US 2026/0281927 A1
(43) Pub. Date: Sep. 17, 2026

(54) ENHANCED REDUCED CAPABILITY SYSTEM INFORMATION AND CONTROL RESOURCE SET

(71) Applicant: QUALCOMM Incorporated, San Diego, CA (US)

(72) Inventors: Ruiming ZHENG, Beijing (CN); Linhai HE, San Diego, CA (US); Jing LEI, San Diego, CA (US)

(21) Appl. No.: 18/873,900

(22) PCT Filed: Aug. 31, 2022
(86) PCT No.: PCT/CN2022/116048

§ 371 Date: Dec. 11, 2024

(51) Int. Cl. H04W 56/00; H04L 5/00; H04W 74/0833

(52) U.S. Cl. CPC H04W 56/002; H04L 5/0044; H04W 74/0833

(57) ABSTRACT

Various aspects of the present disclosure generally relate to wireless communication. In some aspects, a user equipment (UE) may receive, from a network node, a synchronization signal block (SSB) indicating an enhanced reduced capability (eRedCap) specific control resource set (CORESET) that is separate from another CORESET indicated by the SSB. The UE may receive, from the network node, the eRedCap-specific system information from the eRedCap-specific CORESET. Numerous other aspects are described.

### FIELD OF THE DISCLOSURE

Aspects of the present disclosure generally relate to wireless communication and to techniques and apparatuses for enhanced reduced capability system information and control resource set.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promul gated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving, from a network node, a synchronization signal block (SSB) indicating an enhanced reduced capability (eRedCap)-specific control resource set (CORESET) that is separate from another CORESET indicated by the SSB. The method may include receiving, from the network node, eRedCap-specific system information from the eRedCap-specific CORESET.

Some aspects described herein relate to a method of wireless communication performed by a network node. The method may include transmitting an SSB indicating an eRedCap-specific CORESET that is separate from another CORESET indicated by the SSB. The method may include transmitting eRedCap-specific system information using the eRedCap-specific CORESET.

Some aspects described herein relate to an apparatus for wireless communication. The apparatus may include a memory and one or more processors coupled to the memory. The one or more processors may be configured to receive, from a network node, an SSB indicating an eRedCap-specific CORESET that is separate from another CORESET indicated by the SSB. The one or more processors may be configured to receive, from the network node, eRedCap-specific system information from the eRedCap-specific CORESET.

Some aspects described herein relate to a network node for wireless communication. The network node may include a memory and one or more processors coupled to the memory. The one or more processors may be configured to transmit an SSB indicating an eRedCap-specific CORESET that is separate from another CORESET indicated by the SSB. The one or more processors may be configured to transmit eRedCap-specific system information using the eRedCap-specific CORESET.

Some aspects described herein relate to a non-transitory computer-readable medium that stores a set of instructions for wireless communication by a one or more instructions that, when executed by one or more processors of an apparatus. The set of instructions, when executed by one or more processors of the one or more instructions that, when executed by one or more processors of an apparatus, may cause the one or more instructions that, when executed by one or more processors of an apparatus to receive, from a network node, an SSB indicating an eRedCap-specific CORESET that is separate from another CORESET indicated by the SSB. The set of instructions, when executed by one or more processors of the one or more instructions that, when executed by one or more processors of an apparatus, may cause the one or more instructions that, when executed by one or more processors of an apparatus to receive, from the network node, eRedCap-specific system information from the eRedCap-specific CORESET.

Some aspects described herein relate to a non-transitory computer-readable medium that stores a set of instructions for wireless communication by a network node. The set of instructions, when executed by one or more processors of the network node, may cause the network node to transmit an SSB indicating an eRedCap-specific CORESET that is separate from another CORESET indicated by the SSB. The set of instructions, when executed by one or more processors of the network node, may cause the network node to transmit eRedCap-specific system information using the eRedCap-specific CORESET.

Some aspects described herein relate to an apparatus for wireless communication. The apparatus may include means for receiving, from a network node, an SSB indicating an eRedCap-specific CORESET that is separate from another CORESET indicated by the SSB. The apparatus may include means for receiving, from the network node, eRedCap-specific system information from the eRedCap-specific CORESET.

Some aspects described herein relate to an apparatus for wireless communication. The apparatus may include means for transmitting an SSB indicating an eRedCap-specific CORESET that is separate from another CORESET indicated by the SSB. The apparatus may include means for transmitting eRedCap-specific system information using the eRedCap-specific CORESET.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example resource structure for wireless communication, in accordance with the present disclosure.

FIG. 5 is a diagram illustrating an example of an initial access procedure, in accordance with the present disclosure.

FIG. 6 is a diagram illustrating an example associated with configuration of eRedCap-specific CORESET, in accordance with the present disclosure.

FIGS. 7 and 8 are diagrams illustrating example processes associated with eRedCap-specific system information and CORESET, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

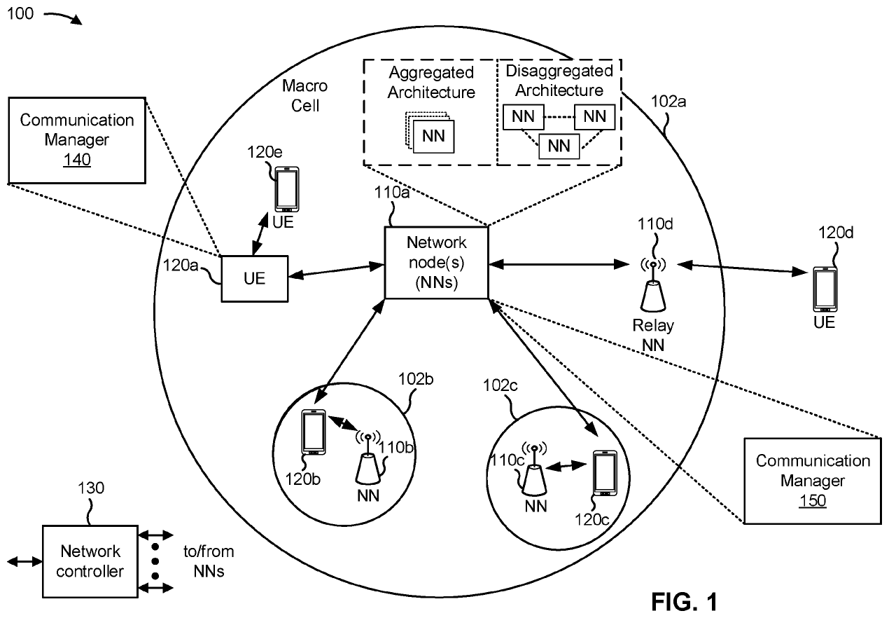

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an apparatus of a UE may include a communication manager 140. As described in more detail elsewhere herein, the communication manager 140 may receive, from a network node, an SSB indicating an eRedCap-specific CORESET that is separate from another CORESET indicated by the SSB; and receive, from the network node, the eRedCap-specific system information from the eRedCap-specific CORESET. Additionally, or alternatively, the communication manager 140 may perform one or more other operations described herein.

In some aspects, the network node 110 may include a communication manager 150. As described in more detail elsewhere herein, the communication manager 150 may transmit an SSB indicating an eRedCap-specific CORESET that is separate from another CORESET indicated by the SSB; and transmit the eRedCap-specific system information using the eRedCap-specific CORESET. Additionally, or alternatively, the communication manager 150 may perform one or more other operations described herein.

As indicated above, FIG. 1 is provided as an example. Other examples may differ from what is described with regard to FIG. 1.

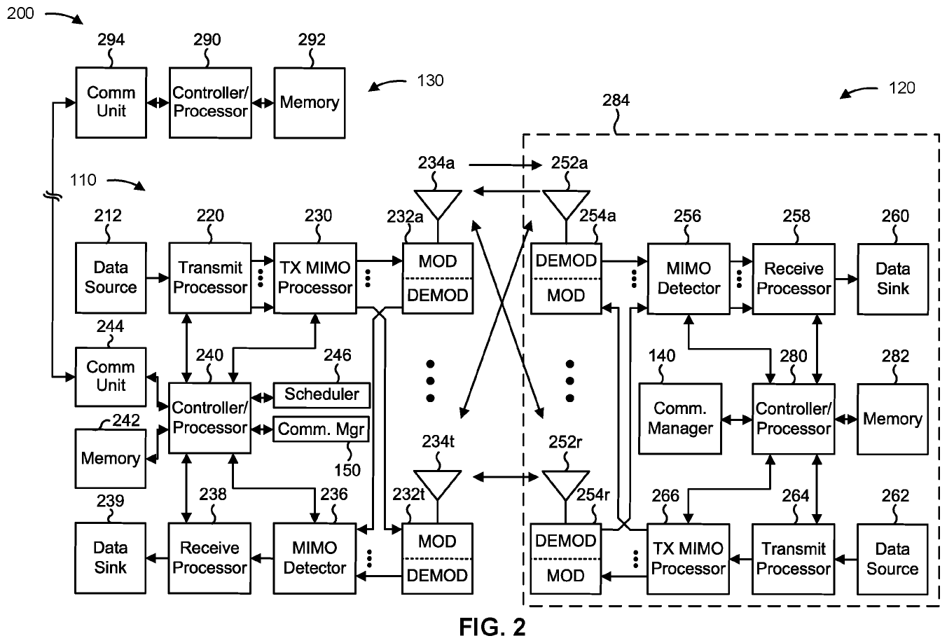

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T′ antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

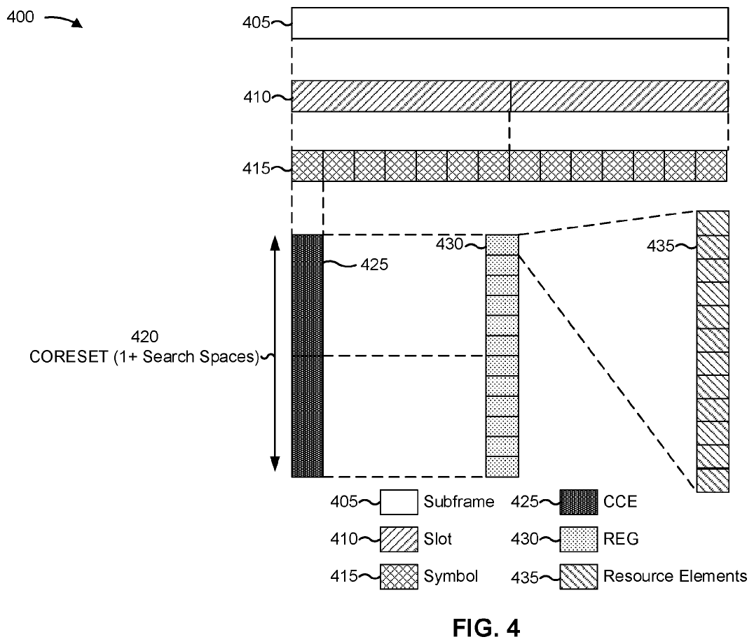

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

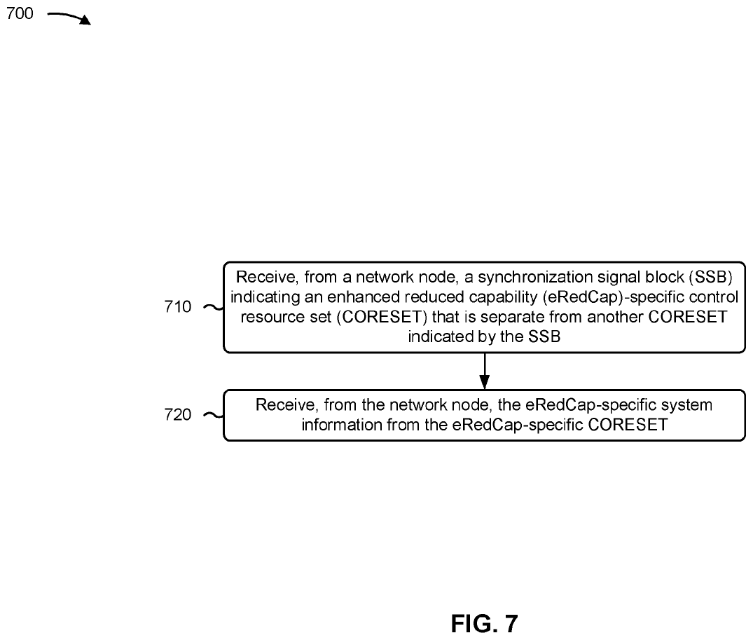

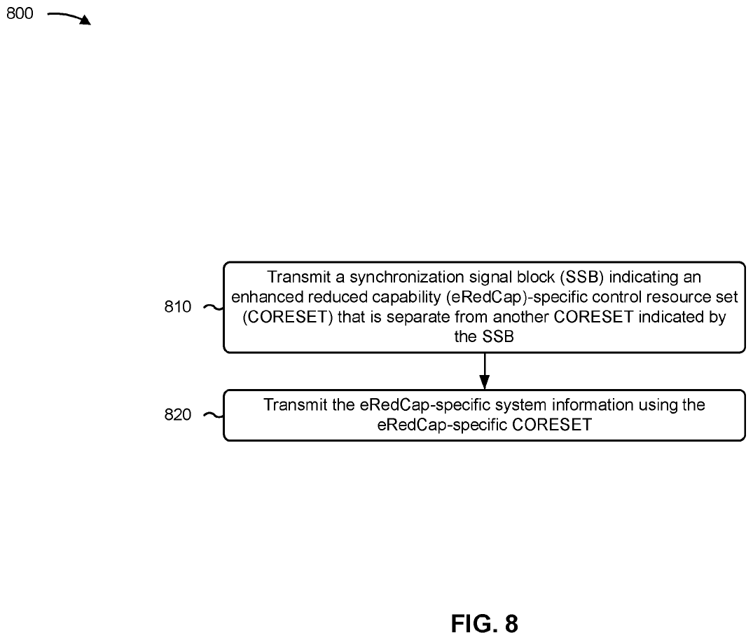

The controller/processor 240 of the network node 110, the controller/processor 280 of the UE 120, and/or any other component(s) of FIG. 2 may perform one or more techniques associated with eRedCap-specific system information and CORESET, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the apparatus of the UE includes means for receiving, from a network node, an SSB indicating an eRedCap-specific CORESET that is separate from another CORESET indicated by the SSB; and/or means for receiving, from the network node, the eRedCap-specific system information from the eRedCap-specific CORESET. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an SSB indicating an eRedCap-specific CORESET that is separate from another CORESET indicated by the SSB; and/or means for transmitting the eRedCap-specific system information using the eRedCap-specific CORESET. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

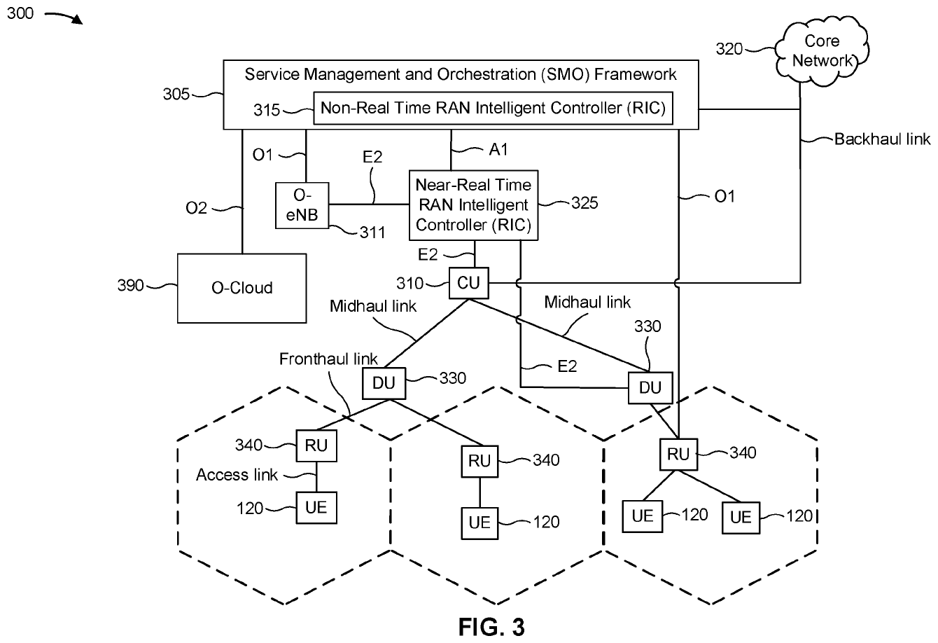

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface) For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1interface) the Near-RT RIC 325. The Near-RT RIC 325 may be configured to include a logical function that enables near-real-time control and optimization of RAN elements and resources via data collection and actions over an interface (such as via an E2interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a CORESET 420 and may be structured to support an efficient use of resources, such as by flexible configuration or reconfiguration of resources of the CORESET 420 for one or more PDCCHs and/or one or more physical downlink shared channels (PDSCHs). In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured, such as by using radio resource control (RRC) signaling to indicate a frequency domain region (e.g., a quantity of resource blocks) and/or a time domain region (e.g., a quantity of symbols) for the CORESET 420. A special type of CORESET 420, referred to as CORESET 0, may be configured based at least in part on a master information block (MIB) included in an SSB transmitted via physical broadcast channel (PBCH). The CORESET 0 may be used to communicate physical downlink control channel (PDCCH) information for communicating system information used for initial access, as described herein.

As illustrated, a symbol 415 that includes CORESET 420 may include one or more control channel elements (CCEs) 425, shown as two CCEs 425 as an example, that span a portion of the system bandwidth. A CCE 425 may include downlink control information (DCI) that is used to provide control information for wireless communication. A network node may transmit DCI during multiple CCEs 425 (as shown), where the quantity of CCEs 425 used for transmission of DCI represents the aggregation level (AL) used by the network node for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space (CSS). The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

As indicated above, FIG. 4 is provided as an example. Other examples may differ from what is described with respect to FIG. 4.

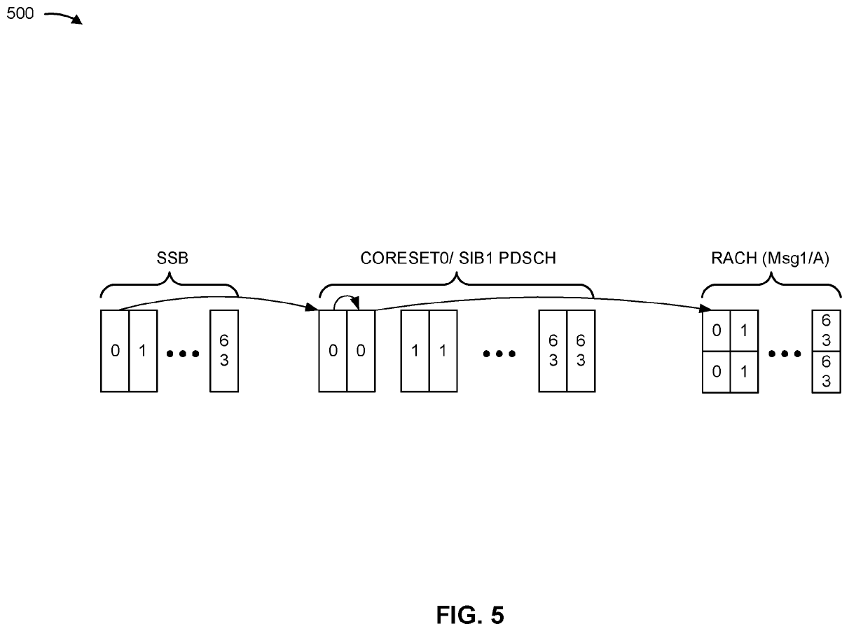

FIG. 5 is a diagram illustrating an example 500 of an initial access procedure, in accordance with the present disclosure.

As shown in FIG. 5, in a 5G NR system, during an initial access, a network node may transmit up to 64 SSB beams. The network node may transmit the SSB beams using time division multiplexing (TDM) and/or frequency division multiplexing (FDM). The network node may transmit the SSB beams based at least in part on a beam sweep. During a cell search, a UE may detect one of the SSB beams. In other words, the UE may detect an SSB from a particular beam. A master information block (MIB) associated with the SSB may configure a CORESET (e.g., CORESET 0) and a search space set (e.g., search space set type 0). The network node may transmit downlink control information (DCI) (e.g.,, DCI format 1_0) based at least in part on the CORESET 0 and the search space set type 0, where the DCI may be cyclic redundancy check (CRC) scrambled by a system information radio network temporary identifier (SI-RNTI). The network node may transmit the DCI via a physical downlink shared channel (PDSCH) communication. The UE may detect the DCI. The DCI may schedule RMSI, which may include a system information block (SIB) 1 (for example, a SIB1 PDSCH). The SIB1 may configure a random access channel (RACH) resouce. The UE may transmit a RACH message to the network node on a RACH occasion based at least in part on the SIB1, where the RACH occasion may be configured by the network node. The RACH message may be a message 1 (Msg1) or message A (MsgA) of a RACH procedure. The UE may access the network node based at least in part on the RACH procedure.

The 5G NR system may support up to 64 SSBs, up to 64 CORESET 0s, up to 64 SIB1 PDSCHs, and up to 64 RACHs. In other words, an SSB, a CORESET 0, a SIB1 PDSCH, and a RACH may be per beam, and resources may be reserved per beam. Multiple initial access channels and messages (for example, all initial access channels or messages) may be repeated per beam, with up to 64 separate beams.

As indicated above, FIG. 5 is provided as an example. Other examples may differ from what is described with regard to FIG. 5.

In some aspects, a network node may serve different UEs of different categories and/or different UEs that support different capabilities. For example, the network node may serve a first category of UEs that have a less advanced capability (e.g., a lower capability and/or a reduced capability) and a second category of UEs that have a more advanced capability (e.g., a higher capability). A UE of the first category may have a reduced feature set compared to UEs of the second category, and may be referred to as a reduced capability (RedCap) UE, a low tier UE, and/or an NR-Lite UE, among other examples. In some aspects, the first category may include a subset of UEs with further reduced capabilities, referred to as enhanced RedCap (eRedCap) UEs, which may have even lower capabilities and/or reduced capabilities, relative to RedCap UEs. A UE of the first category may be, for example, an MTC UE, an eMTC UE, and/or an IoT UE, as described above in connection with FIG. 1. A UE of the second category may have an advanced feature set compared to UEs of the second category, and may be referred to as a baseline UE, a high tier UE, an NR UE, and/or a premium UE, among other examples. In some aspects, a UE of the first category has capabilities that satisfy requirements of a first (earlier) wireless communication standard but not a second (later) wireless communication standard, while a UE of the second category has capabilities that satisfy requirements of the second (later) wireless communication standard (and also the first wireless communication standard, in some cases).

For example, eRedCap UEs may support a lower maximum modulation and coding scheme (MCS) than RedCap UEs and UEs of the second category (e.g., quadrature phase shift keying (QPSK) or the like as compared to 256-quadrature amplitude modulation (QAM) or the like), may support a lower maximum transmit power than RedCap UEs and/or UEs of the second category, may have a less advanced beamforming capability than RedCap UEs and/or UEs of the second category (e.g., may not be capable of forming as many beams as RedCap UEs and/or UEs of the second category), may require a longer processing time than RedCap UEs and/or UEs of the second category, may include less hardware than RedCap UEs and/or UEs of the second category (e.g., fewer antennas, fewer transmit antennas, and/or fewer receive antennas), and/or may not be capable of communicating on as wide of a maximum bandwidth part as RedCap UEs and/or UEs of the second category, among other examples. Additionally, or alternatively, RedCap UEs and/or UEs of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and eRedCap UEs of the first category may not be capable of communicating using the shortened TTI.

The separate capabilities of different types of UEs (e.g., baseline UEs, RedCap UEs, and eRedCap UEs) may support the scalability and efficiency of wireless communication networks by enabling a network deployment to use reduced resources for communications with lower tier UEs. As an example, baseline UEs often operate in and support channel bandwidths between 50 MHz and 400 MHz and subcarrier spacing between 15KHz and 260KHz; RedCap UEs may operate in and support channel bandwidth as low as 20 MHz and subcarrier spacing of 15KHz; and eRedCap UEs may operate in and support channel bandwidths as low as 5 MHz with 15KHz subcarrier spacing. The support of lower bandwidth and subcarrier spacing may enable network nodes to relax various communication requirements, such as peak throughput, latency, and reliability requirements, and enables the network node to conserve communication resources when communicating with RedCap and eRedCap UEs. However, in the 5 MHz bandwidth, CORESET 0 support is limited, and in some situations, only 24 RBs of the CORESET 0 are supported with 15 KHz subcarrier spacing. In addition, CORESET 0 for baseline UEs may use bandwidths not supported by eRedCap UEs. As a result, eRedCap UEs may be to communicate in only a limited fashion when a CORESET 0 includes resources beyond the eRedCap UEs' capabilities. This may lead to high latency, low throughput, and wasted energy attempting to communicate using resources that are not tailored for eRedCap UEs' capabilities.

Some techniques and apparatuses described herein enable configuration and use of an eRedCap specific CORESET. For example, a network node may transmit an SSB that indicates an eRedCap-specific CORESET, which is separate from another CORESET indicated by the SSB (e.g., the other CORESET intended for use by non-eRedCap UEs). The eRedCap-specific CORESET may support smaller bandwidths and subcarrier spacing used by eRedCap UEs. An eRedCap UE may use the eRedCap-specific CORESET to receive system information that is also eRedCap-specific, such as eRedCap specific system information blocks (SIBs), eRedCap-specific initial downlink and/or uplink bandwidth parts, and/or eRedCap-specific CSS for system information, paging resources, and random access communications resources, among other examples. In some aspects, the eRedCap-specific system information may support multiplexing (both TDM, and FDM, full-duplex and half-duplex) communications, such as multiplexing of initial bandwidth parts. As a result, a network node may support reduced capabilities of eRedCap UEs in a flexible manner that is based on eRedCap UE capabilities. In this way, the network node may conserve resources, such as communication, processing, and power resources, when communicating with eRedCap UEs by reducing throughput, latency, and/or reliability requirements relative to non-eRedCap communications. In addition, eRedCap UEs may have improved communication throughput and latency using multiplexing patterns that might not otherwise be available to eRedCap UEs.

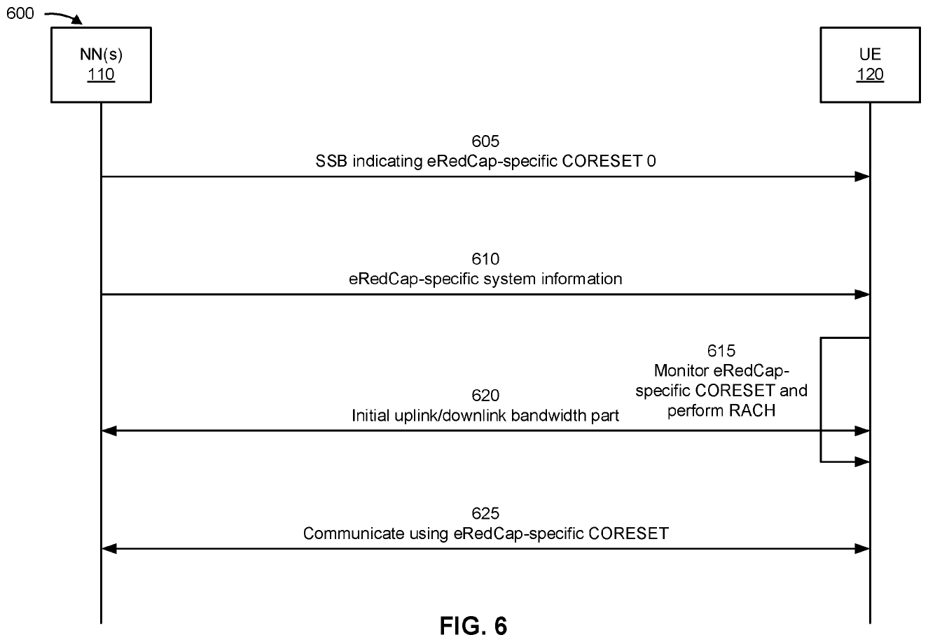

FIG. 6 is a diagram illustrating an example 600 associated with configuration of eRedCap-specific CORESET, in accordance with the present disclosure. As shown in FIG. 6, one or more network nodes (e.g., network node 110) and an eRedCap UE (e.g., UE 120) may communicate with one another.

As shown by reference number 605, a network node may transmit, and the eRedCap UE may receive, an SSB (e.g., a cell-defining SSB or non-cell-defining SSB) indicating an eRedCap-specific CORESET. The eRedCap-specific CORESET may be separate from another CORESET (e.g., for non-eRedCap UEs) that is also indicated in the same SSB. For example, the SSB may include a master information block (MIB) that includes a system information parameter (e.g., pdcch-ConfigSIB1 or another parameter) that indicates the network node is configured with the eRedCap-specific CORESET.

In some aspects, the eRedCap-specific CORESET and Type 0 CSS for eRedCap may be mapped to resources with semi-static time and/or frequency offsets from the SSB. For example, the offset may be a frequency offset that shares the same time domain or a time offset (e.g., an offset in terms of a number of symbols, slots, and/or RBs, such as a 0 RB offset, 2 RB offset, or 4RB offset, among other examples). In some aspects, the SSB and eRedCap-specific CORESET 0, for example, may have different numerologies (or the same numerologies), but occur at the same time instance, e.g., relying on FDM. In some aspects, RF retuning may be used to enable the eRedCap UE to monitor on and/or receive on different frequencies.

In some aspects, the SSB may be eRedCap-specific. For example, the network node may be configured with an eRedCap-specific SSB that is separate from an SSB intended for non-eRedCap UEs.

As shown by reference number 610, the network node may transmit, and the UE may receive, eRedCap-specific system information from the eRedCap-specific CORESET. For example, the eRedCap-specific system information may be included in one or more system information blocks (SIBs), including a SIB1 included in eRedCap-specific CORESET 0. In some aspects, the e-RedCap-specific system information may be associated with an eRedCap-specific system information radio network temporary identifier (SI-RNTI).

In some aspects, the SIBs may be eRedCap-specific SIBs. For example, the network node may be configured to transmit eRedCap-specific SIBs via the eRedCap-specific CORESET, in addition to separately transmitted SIBs intended for non-eRedCap UEs. In this situation, eRedCap-specific CSS for paging, other SIBs, and random access, may be indicated by eRedCap-specific SIB1 included in the eRedCap-specific CORESET 0.

In some aspects, the SIBs may not be specific to eRedCap UEs. In this situation, the eRedCap UE may obtain system information from a SIB1 that is not eRedCap specific, which may be included in a CORESET 0 that is not eRedCap-specific. For example, a SIB1 intended for non-eRedCap UEs may also include at least one eRedCap-specific parameter, such as RRC parameters for eRedCap-specific initial bandwidth parts, CSS for paging, other SIBs, and random access.

In some aspects, to receive the eRedCap-specific system information from the eRedCap-specific CORESET, the eRedCap UE may perform radio frequency retuning, based at least in part on the SSB (e.g., based at least in part on information included in the MIB), to receive the eRedCap-specific system information from the eRedCap-specific CORESET. For example, RF retuning may be used when eRedCap-specific CORESET is in a separate frequency from the SSB.

In some aspects, the eRedCap UE may configure the eRedCap UE based at least in part on the eRedCap-specific system information. For example, the eRedCap UE may configure resources to monitor, RF retuning parameters, and/or the like, to facilitate further communications with the network node. For example, the eRedCap UE may configure itself to use an eRedCap-specific initial uplink bandwidth part, initial downlink bandwidth part, and/or CSS for paging and random access, among other examples.

As shown by reference number 615, the eRedCap UE may monitor one or more paging occasions in the eRedCap-specific CORESET, in an eRedCap-specific initial downlink bandwidth part, while performing a RACH procedure. For example, the eRedCap UE may be configured with separate eRedCap-specific initial downlink bandwidth parts, with an eRedCap-specific CSS for paging and random access. In this situation, the eRedCap UE may camp on the eRedCap-specific CORESET 0 while also performing RACH in the separate initial bandwidth part.

As shown by reference number 620, the eRedCap UE may communicate with the network node using a second bandwidth part that is separate from the first bandwidth part. The first bandwidth part may be an uplink or downlink bandwidth part and the second bandwidth part may be an uplink or downlink bandwidth part. Additional bandwidth parts may also be use for communications between the network node and the eRedCap UE. In some aspects, RACH may be configured using one or more of the first bandwidth part, the second bandwidth part, or another bandwidth part. For example, as described herein, the eRedCap UE may perform a RACH procedure using the second bandwidth part (e.g., the second bandwidth part may include resources for RACH). In this way, RACH may be offloaded to a separate bandwidth part from the bandwidth part used to receive system information.

In some aspects, the eRedCap-specific system information may be time-domain duplexed with another communication using the second bandwidth part. Additionally, or alternatively, a first center frequency of the first bandwidth part may be different from a second center frequency of the second bandwidth part. In some aspects, separate RACH occasion resources may be configured in separate eRedCap-specific initial uplink bandwidth parts. In some aspects, separate RACH resources, including monitoring windows and/or timers, may be configured in separate eRedCap-specific initial downlink bandwidth parts. For example, the network node may transmit, to the eRedCap UE, in an initial downlink bandwidth part, RACH configuration information for performing RACH.

In some aspects, a RACH procedure may be configured using the second bandwidth part and based at least in part on an eRedCap-specific configured radio frequency retune gap. For example, when communicating using separate bandwidth parts, the eRedCap UE may retune to different frequencies associated with the separate bandwidth parts, which may have an associated RF retune time, or RF retune gap. In this situation, the eRedCap-specific UE may configure RACH to account for the RF retune gap. The RF retune gap may impact a random access monitoring time window and/or starting point of a random access monitoring window.

In some aspects, performing the RACH procedure using a second bandwidth part may be based at least in part on a width of a non-eRedCap-specific initial uplink bandwidth part and a capability of the eRedCap UE. For example, a default initial uplink bandwidth part for a non-eRedCap UE may be wider than the eRedCap UE is capable of receiving. In this situation, one or more separate initial uplink bandwidth parts may be configured, e.g., using a bandwidth within the capabilities of the eRedCap UE.

In some aspects, separate bandwidth parts may be separately configured via radio resource control (RRC) configuration or using eRedCap-specific system information. In some aspects, the separately configured bandwidth parts include an initial downlink bandwidth part and an initial uplink bandwidth part. Separate configurations for the bandwidth parts may include at least one of: a time division duplex configuration, or a frequency division duplex configuration (e.g., including half-duplex or full-duplex configurations).

As shown by reference number 625, the network node and UE may continue to communicate using the eRedCap-specific CORESET. For example, other system information, including SIBs other than SIB1, may be communicated using the eRedCap-specific CORESET. Additionally, or alternatively, further RACH communications may take place using the eRedCap-specific CORESET and/or other resources identified by system information included in the eRedCap-specific CORESET.

As a result, the network node may support reduced capabilities of the eRedCap UE in a flexible manner that is based on the eRedCap UE capabilities. In this way, the network node may conserve resources, such as communication, processing, and power resources, when communicating with the eRedCap UE (e.g., by reducing throughput, latency, and/or reliability requirements relative to non-eRedCap communications). In addition, the eRedCap UE may have improved communication throughput and latency using eRedCap-specific resources and multiplexing patterns that might not otherwise be available to eRedCap UEs.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., an eRedCap UE, such as UE 120) performs operations associated with eRedCap-specific system information and CORESET.

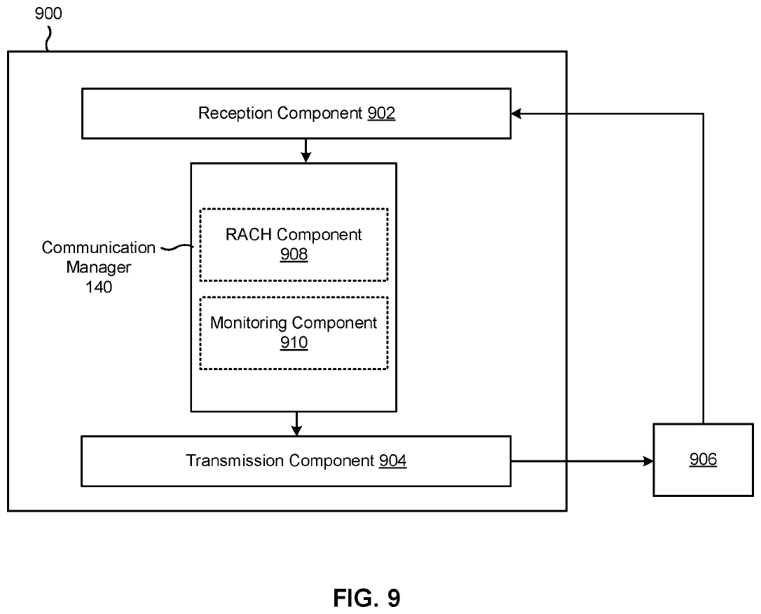

As shown in FIG. 7, in some aspects, process 700 may include receiving, from a network node, an SSB indicating an eRedCap-specific CORESET that is separate from another CORESET indicated by the SSB (block 710). For example, the UE (e.g., using communication manager 140 and/or reception component 902, depicted in FIG. 9) may receive, from a network node, a SSB indicating an eRedCap-specific CORESET that is separate from another CORESET indicated by the SSB, as described above.

As further shown in FIG. 7, in some aspects, process 700 may include receiving, from the network node, the eRedCap-specific system information from the eRedCap-specific CORESET (block 720). For example, the UE (e.g., using communication manager 140 and/or reception component 902, depicted in FIG. 9) may receive, from the network node, the eRedCap-specific system information from the eRedCap-specific CORESET, as described above.

Process 700 may include additional aspects, such as any single aspect or any combination of aspects described below and/or in connection with one or more other processes described elsewhere herein.

In a first aspect, the eRedCap-specific system information is included in eRedCap-specific SIBs.

In a second aspect, alone or in combination with the first aspect, the eRedCap-specific system information is included in SIBs that are not eRedCap-specific.

In a third aspect, alone or in combination with one or more of the first and second aspects, the SIBs include at least one eRedCap-specific parameter.

In a fourth aspect, alone or in combination with one or more of the first through third aspects, the eRedCap-specific system information indicates an eRedCap-specific resource that includes at least one of an eRedCap-specific initial downlink bandwidth part, an eRedCap-specific initial uplink bandwidth part, or an eRedCap-specific common search space for the system information, paging, and random access communications.

In a fifth aspect, alone or in combination with one or more of the first through fourth aspects, process 700 includes performing a RACH procedure using an eRedCap-specific initial downlink bandwidth part, and monitoring one or more paging occasions in the eRedCap-specific CORESET, in the eRedCap-specific initial downlink bandwidth part, while performing the RACH procedure.

In a sixth aspect, alone or in combination with one or more of the first through fifth aspects, the SSB includes a system information parameter that maps to the eRedCap-specific CORESET.

In a seventh aspect, alone or in combination with one or more of the first through sixth aspects, the SSB is configured to be an eRedCap-specific SSB, and the eRedCap-specific CORESET is associated with a frequency domain offset.

In an eighth aspect, alone or in combination with one or more of the first through seventh aspects, the eRedCap-specific system information is associated with an eRedCap-specific system information radio network temporary identifier.

In a ninth aspect, alone or in combination with one or more of the first through eighth aspects, receiving the eRedCap-specific system information from the eRedCap-specific CORESET comprises performing radio frequency retuning, based at least in part on the SSB, to receive the eRedCap-specific system information from the eRedCap-specific CORESET.

In a tenth aspect, alone or in combination with one or more of the first through ninth aspects, the eRedCap-specific system information is received using a first bandwidth part, and wherein the method further comprises communicating with the network node using a second bandwidth part that is separate from the first bandwidth part.

In an eleventh aspect, alone or in combination with one or more of the first through tenth aspects, communicating with the network node using the second bandwidth part comprises configuring a random access channel (RACH) procedure using the second bandwidth part.

In a twelfth aspect, alone or in combination with one or more of the first through eleventh aspects, configuring the RACH procedure using the second bandwidth part is based at least in part on a width of a non-eRedCap-specific initial uplink bandwidth part and a capability of the UE.

In a thirteenth aspect, alone or in combination with one or more of the first through twelfth aspects, separating RACH occasion resources are configured in separate eRedCap-specific initial uplink bandwidth parts.

In a fourteenth aspect, alone or in combination with one or more of the first through thirteenth aspects, the eRedCap-specific system information and a communication using the second bandwidth part are time domain duplexed, and a first center frequency of the first bandwidth part is different from a second center frequency of the second bandwidth part.

In a fifteenth aspect, alone or in combination with one or more of the first through fourteenth aspects, communicating with the network node using the second bandwidth part comprises configuring a random access channel (RACH) procedure using the second bandwidth part and based at least in part on an eRedCap-specific configured radio frequency retune gap, wherein separate RACH occasion resources are configured in separate eRedCap-specific initial uplink bandwidth parts.

In a sixteenth aspect, alone or in combination with one or more of the first through fifteenth aspects, the first bandwidth part and the second bandwidth part are separately configured via at least one of radio resource control (RRC) configuration, or the eRedCap-specific system information.

In a seventeenth aspect, alone or in combination with one or more of the first through sixteenth aspects, the first bandwidth part is an initial downlink bandwidth part, and the second bandwidth part is an initial uplink bandwidth part.

In an eighteenth aspect, alone or in combination with one or more of the first through seventeenth aspects, separating configurations for the first bandwidth part and the second bandwidth part may include at least one of a time division duplex configuration, or a frequency division duplex configuration.

In a nineteenth aspect, alone or in combination with one or more of the first through eighteenth aspects, the UE is an eRedCap UE.

In a twentieth aspect, alone or in combination with one or more of the first through nineteenth aspects, the SSB is a cell-defining SSB.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with eRedCap-specific system information and CORESET.

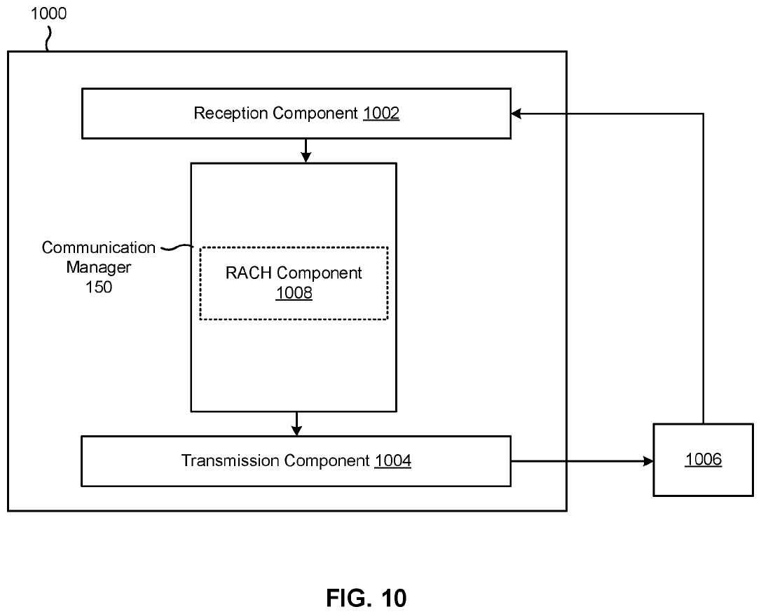

As shown in FIG. 8, in some aspects, process 800 may include transmitting an SSB indicating an eRedCap-specific CORESET that is separate from another CORESET indicated by the SSB (block 810). For example, the network node (e.g., using communication manager 150 and/or transmission component 1004, depicted in FIG. 10) may transmit a SSB indicating an eRedCap-specific CORESET that is separate from another CORESET indicated by the SSB, as described above.

As further shown in FIG. 8, in some aspects, process 800 may include transmitting the eRedCap-specific system information using the eRedCap-specific CORESET (block 820). For example, the network node (e.g., using communication manager 150 and/or transmission component 1004, depicted in FIG. 10) may transmit the eRedCap-specific system information using the eRedCap-specific CORESET, as described above.

Process 800 may include additional aspects, such as any single aspect or any combination of aspects described below and/or in connection with one or more other processes described elsewhere herein.

In a first aspect, the eRedCap-specific system information is included in eRedCap-specific SIBs.

In a second aspect, alone or in combination with the first aspect, the eRedCap-specific system information is included in SIBs that are not eRedCap-specific.

In a third aspect, alone or in combination with one or more of the first and second aspects, the SIBs include at least one eRedCap-specific parameter.

In a fourth aspect, alone or in combination with one or more of the first through third aspects, the eRedCap-specific system information indicates an eRedCap-specific resource that includes at least one of an eRedCap-specific initial downlink bandwidth part, an eRedCap-specific initial uplink bandwidth part, or an eRedCap-specific common search space for the system information, paging, and random access communications.

In a fifth aspect, alone or in combination with one or more of the first through fourth aspects, process 800 includes performing a RACH procedure using an eRedCap-specific initial downlink bandwidth part.

In a sixth aspect, alone or in combination with one or more of the first through fifth aspects, the SSB includes a system information parameter that maps to the eRedCap-specific CORESET.

In a seventh aspect, alone or in combination with one or more of the first through sixth aspects, the SSB is configured to be an eRedCap-specific SSB, and the eRedCap-specific CORESET is associated with a frequency domain offset.

In an eighth aspect, alone or in combination with one or more of the first through seventh aspects, the eRedCap-specific system information is associated with an eRedCap-specific system information radio network temporary identifier.

In a ninth aspect, alone or in combination with one or more of the first through eighth aspects, the eRedCap-specific system information is transmitted using a first bandwidth part, and wherein the method further comprises communicating with a UE using a second bandwidth part that is separate from the first bandwidth part.

In a tenth aspect, alone or in combination with one or more of the first through ninth aspects, communicating with the UE using the second bandwidth part comprises performing a RACH procedure using the second bandwidth part.

In an eleventh aspect, alone or in combination with one or more of the first through tenth aspects, configuring the RACH procedure using the second bandwidth part is based at least in part on a width of a non-eRedCap-specific initial uplink bandwidth part and a capability of the UE.

In a twelfth aspect, alone or in combination with one or more of the first through eleventh aspects, separating RACH occasion resources are configured in separate eRedCap-specific initial uplink bandwidth parts.

In a thirteenth aspect, alone or in combination with one or more of the first through twelfth aspects, the eRedCap-specific system information and a communication using the second bandwidth part are time domain duplexed, and a first center frequency of the first bandwidth part is different from a second center frequency of the second bandwidth part.

In a fourteenth aspect, alone or in combination with one or more of the first through thirteenth aspects, communicating with the UE using the second bandwidth part comprises performing a RACH procedure using the second bandwidth part and based at least in part on an eRedCap-specific configured radio frequency retune gap, wherein separate RACH occasion resources are configured in separate eRedCap-specific initial uplink bandwidth parts.

In a fifteenth aspect, alone or in combination with one or more of the first through fourteenth aspects, the first bandwidth part and the second bandwidth part are separately configured via at least one of RRC configuration, or the eRedCap-specific system information.

In a sixteenth aspect, alone or in combination with one or more of the first through fifteenth aspects, the first bandwidth part is an initial downlink bandwidth part, and the second bandwidth part is an initial uplink bandwidth part.

In a seventeenth aspect, alone or in combination with one or more of the first through sixteenth aspects, separating configurations for the first bandwidth part and the second bandwidth part may include at least one of a time division duplex configuration, or a frequency division duplex configuration.

In an eighteenth aspect, alone or in combination with one or more of the first through seventeenth aspects, the SSB is a cell-defining SSB.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a RACH component 908, or a monitoring component 910, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network node, an SSB indicating an eRedCap-specific CORESET that is separate from another CORESET indicated by the SSB. The reception component 902 may receive, from the network node, the eRedCap-specific system information from the eRedCap-specific CORESET.

The RACH component 908 may perform a RACH procedure using an eRedCap-specific initial downlink bandwidth part.

The monitoring component 910 may monitor one or more paging occasions in the eRedCap-specific CORESET, in the eRedCap-specific initial downlink bandwidth part, while performing the RACH procedure.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150) may include a RACH component 1008, among other examples.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit an SSB indicating an eRedCap-specific CORESET that is separate from another CORESET indicated by the SSB. The transmission component 1004 may transmit the eRedCap-specific system information using the eRedCap-specific CORESET.

The RACH component 1008 may perform a RACH procedure using an eRedCap-specific initial uplink and/or downlink bandwidth part.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by an apparatus of a UE, comprising: receiving, from a network node, an SSB indicating an eRedCap-specific CORESET that is separate from another CORESET indicated by the SSB; and receiving, from the network node, the eRedCap-specific system information from the eRedCap-specific CORESET.

Aspect 2: The method of Aspect 1, wherein the eRedCap-specific system information is included in eRedCap-specific SIBs.

Aspect 3: The method of any of Aspects 1-2, wherein the eRedCap-specific system information is included in SIBs that are not eRedCap-specific.

Aspect 4: The method of Aspect 3, wherein the SIBs include at least one eRedCap-specific parameter.

Aspect 5: The method of any of Aspects 1-4, wherein the eRedCap-specific system information indicates an eRedCap-specific resource that includes at least one of: an eRedCap-specific initial downlink bandwidth part, an eRedCap-specific initial uplink bandwidth part, or an eRedCap-specific common search space for the system information, paging, and random access communications.

Aspect 6: The method of any of Aspects 1-5, further comprising: performing a RACH procedure using an eRedCap-specific initial downlink bandwidth part; and monitoring one or more paging occasions in the eRedCap-specific CORESET, in the eRedCap-specific initial downlink bandwidth part, while performing the RACH procedure.

Aspect 7: The method of any of Aspects 1-6, wherein the SSB includes a system information parameter that maps to the eRedCap-specific CORESET.

Aspect 8: The method of any of Aspects 1-7, wherein the SSB is configured to be an eRedCap-specific SSB, and wherein the eRedCap-specific CORESET is associated with a frequency domain offset.

Aspect 9: The method of any of Aspects 1-8, wherein the eRedCap-specific system information is associated with an eRedCap-specific system information radio network temporary identifier.

Aspect 10: The method of any of Aspects 1-9, wherein receiving the eRedCap-specific system information from the eRedCap-specific CORESET comprises: performing radio frequency retuning, based at least in part on the SSB, to receive the eRedCap-specific system information from the eRedCap-specific CORESET.

Aspect 11: The method of any of Aspects 1-10, wherein the eRedCap-specific system information is received using a first bandwidth part; and wherein the method further comprises: communicating with the network node using a second bandwidth part that is separate from the first bandwidth part.

Aspect 12: The method of Aspect 11, wherein communicating with the network node using the second bandwidth part comprises: performing a RACH procedure using the second bandwidth part.

Aspect 13: The method of Aspect 12, wherein configuring the RACH procedure using the second bandwidth part is based at least in part on a width of a non-eRedCap-specific initial uplink bandwidth part and a capability of the UE.

Aspect 14: The method of Aspect 12, wherein separate RACH occasion resources are configured in separate eRedCap-specific initial uplink bandwidth parts.

Aspect 15: The method of any of Aspects 11-14, wherein the eRedCap-specific system information and a communication using the second bandwidth part are time domain duplexed, and a first center frequency of the first bandwidth part is different from a second center frequency of the second bandwidth part.

Aspect 16: The method of Aspect 15, wherein communicating with the network node using the second bandwidth part comprises: performing a RACH procedure using the second bandwidth part and based at least in part on an eRedCap-specific configured radio frequency retune gap, wherein separate RACH occasion resources are configured in separate eRedCap-specific initial uplink bandwidth parts.

Aspect 17: The method of any of Aspects 11-16, wherein the first bandwidth part and the second bandwidth part are separately configured via at least one of: RRC configuration, or the eRedCap-specific system information.

Aspect 18: The method of Aspect 17, wherein the first bandwidth part is an initial downlink bandwidth part, and the second bandwidth part is an initial uplink bandwidth part.

Aspect 19: The method of Aspect 17, wherein separate configurations for the first bandwidth part and the second bandwidth part may include at least one of: a time division duplex configuration, or a frequency division duplex configuration.

Aspect 20: The method of any of Aspects 1-19, wherein the UE is an eRedCap UE.

Aspect 21: The method of any of Aspects 1-20, wherein the SSB is a cell-defining SSB.

Aspect 22: A method of wireless communication performed by a network node, comprising: transmitting an SSB indicating an eRedCap-specific CORESET that is separate from another CORESET indicated by the SSB; and transmitting the eRedCap-specific system information using the eRedCap-specific CORESET.

Aspect 23: The method of Aspect 22, wherein the eRedCap-specific system information is included in eRedCap-specific SIBs.

Aspect 24: The method of any of Aspects 22-23, wherein the eRedCap-specific system information is included in SIBs that are not eRedCap-specific.

Aspect 25: The method of Aspect 24, wherein the SIBs include at least one eRedCap-specific parameter.

Aspect 26: The method of any of Aspects 22-25, wherein the eRedCap-specific system information indicates an eRedCap-specific resource that includes at least one of: an eRedCap-specific initial downlink bandwidth part, an eRedCap-specific initial uplink bandwidth part, or an eRedCap-specific common search space for the system information, paging, and random access communications.

Aspect 27: The method of any of Aspects 22-26, further comprising: performing a RACH procedure using an eRedCap-specific initial downlink bandwidth part.

Aspect 28: The method of any of Aspects 22-27, wherein the SSB includes a system information parameter that maps to the eRedCap-specific CORESET.

Aspect 29: The method of any of Aspects 22-28, wherein the SSB is configured to be an eRedCap-specific SSB, and wherein the eRedCap-specific CORESET is associated with a frequency domain offset.

Aspect 30: The method of any of Aspects 22-29, wherein the eRedCap-specific system information is associated with an eRedCap-specific system information radio network temporary identifier.

Aspect 31: The method of any of Aspects 22-30, wherein the eRedCap-specific system information is transmitted using a first bandwidth part; and wherein the method further comprises: communicating with a UE using a second bandwidth part that is separate from the first bandwidth part.

Aspect 32: The method of Aspect 31, wherein communicating with the UE using the second bandwidth part comprises: performing a RACH procedure using the second bandwidth part.

Aspect 33: The method of Aspect 32, wherein configuring the RACH procedure using the second bandwidth part is based at least in part on a width of a non-eRedCap-specific initial uplink bandwidth part and a capability of the UE.

Aspect 34: The method of Aspect 32, wherein separate RACH occasion resources are configured in separate eRedCap-specific initial uplink bandwidth parts.

Aspect 35: The method of any of Aspects 31-34, wherein the eRedCap-specific system information and a communication using the second bandwidth part are time domain duplexed, and a first center frequency of the first bandwidth part is different from a second center frequency of the second bandwidth part.

Aspect 36: The method of Aspect 35, wherein communicating with the UE using the second bandwidth part comprises: performing a RACH procedure using the second bandwidth part and based at least in part on an eRedCap-specific configured radio frequency retune gap, wherein separate RACH occasion resources are configured in separate eRedCap-specific initial uplink bandwidth parts.

Aspect 37: The method of any of Aspects 31-36, wherein the first bandwidth part and the second bandwidth part are separately configured via at least one of: RRC configuration, or the eRedCap-specific system information.

Aspect 38: The method of Aspect 37, wherein the first bandwidth part is an initial downlink bandwidth part, and the second bandwidth part is an initial uplink bandwidth part.

Aspect 39: The method of Aspect 37, wherein separate configurations for the first bandwidth part and the second bandwidth part may include at least one of: a time division duplex configuration, or a frequency division duplex configuration.

Aspect 40: The method of any of Aspects 22-39, wherein the SSB is a cell-defining SSB.

Aspect 41: An apparatus for wireless communication at a device, comprising a processor; memory coupled with the processor; and instructions stored in the memory and executable by the processor to cause the apparatus to perform the method of one or more of Aspects 1-21.

Aspect 42: An apparatus for wireless communication at a device, comprising a processor; memory coupled with the processor; and instructions stored in the memory and executable by the processor to cause the apparatus to perform the method of one or more of Aspects 22-40.

Aspect 43: A device for wireless communication, comprising a memory and one or more processors coupled to the memory, the one or more processors configured to perform the method of one or more of Aspects 1-21.

Aspect 44: A device for wireless communication, comprising a memory and one or more processors coupled to the memory, the one or more processors configured to perform the method of one or more of Aspects 22-40.

Aspect 45: An apparatus for wireless communication, comprising at least one means for performing the method of one or more of Aspects 1-21

Aspect 46: An apparatus for wireless communication, comprising at least one means for performing the method of one or more of Aspects 22-40.

Aspect 47: A non-transitory computer-readable medium storing code for wireless communication, the code comprising instructions executable by a processor to perform the method of one or more of Aspects 1-21

Aspect 48: A non-transitory computer-readable medium storing code for wireless communication, the code comprising instructions executable by a processor to perform the method of one or more of Aspects 22-40.

Aspect 49: A non-transitory computer-readable medium storing a set of instructions for wireless communication, the set of instructions comprising one or more instructions that, when executed by one or more processors of a device, cause the device to perform the method of one or more of Aspects 1-21.

Aspect 50: A non-transitory computer-readable medium storing a set of instructions for wireless communication, the set of instructions comprising one or more instructions that, when executed by one or more processors of a device, cause the device to perform the method of one or more of Aspects 22-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node, a synchronization signal block (SSB) indicating an enhanced reduced capability (eRedCap)-specific control resource set (CORESET) that is separate from another CORESET indicated by the SSB; and
receive, from the network node, eRedCap-specific system information from the eRedCap-specific CORESET.

2. The UE of claim 1, wherein the eRedCap-specific system information is included in eRedCap-specific system information blocks (SIBs).

3. The UE of claim 1, wherein the eRedCap-specific system information is included in system information blocks (SIBs) that are not eRedCap-specific.

4. The UE of claim 3, wherein the SIBs include at least one eRedCap-specific parameter.

5. The UE of claim 1, wherein the eRedCap-specific system information indicates an eRedCap-specific resource that includes at least one of:
an eRedCap-specific initial downlink bandwidth part,
an eRedCap-specific initial uplink bandwidth part, or
an eRedCap-specific common search space for the eRedCap-specific system information, paging, and random access communications.

6. The UE of claim 1, wherein the one or more processors are further configured to:
perform a random access channel (RACH) procedure using an eRedCap-specific initial downlink bandwidth part; and
monitor one or more paging occasions in the eRedCap-specific CORESET, in the eRedCap-specific initial downlink bandwidth part, while performing the RACH procedure.

7. The UE of claim 1, wherein the SSB includes a system information parameter that maps to the eRedCap-specific CORESET.

8. The UE of claim 1, wherein the SSB is configured to be an eRedCap-specific SSB, and wherein the eRedCap-specific CORESET is associated with a frequency domain offset.

9. The UE of claim 1, wherein the eRedCap-specific system information is associated with an eRedCap-specific system information radio network temporary identifier.

10. The UE of claim 1, wherein the one or more processors, to receive the eRedCap-specific system information from the eRedCap-specific CORESET, are configured to:
perform radio frequency retuning, based at least in part on the SSB, to receive the eRedCap-specific system information from the eRedCap-specific CORESET.

11. The UE of claim 1, wherein the eRedCap-specific system information is received using a first bandwidth part; and
wherein the one or more processors are further configured to:
communicate with the network node using a second bandwidth part that is separate from the first bandwidth part.

12. The UE of claim 11, wherein the one or more processors, to communicate with the network node using the second bandwidth part, are configured to:
perform a random access channel (RACH) procedure using the second bandwidth part.

13. The UE of claim 12, wherein performing the RACH procedure using the second bandwidth part is based at least in part on a width of a non-eRedCap-specific initial uplink bandwidth part and a capability of the UE.

14. The UE of claim 12, wherein separate RACH occasion resources are configured in separate eRedCap-specific initial uplink bandwidth parts.

15. The UE of claim 11, wherein the eRedCap-specific system information and a communication using the second bandwidth part are time domain duplexed, and a first center frequency of the first bandwidth part is different from a second center frequency of the second bandwidth part.

16. The UE of claim 15, wherein the one or more processors, to communicate with the network node using the second bandwidth part, are configured to:
perform a random access channel (RACH) procedure using the second bandwidth part and based at least in part on an eRedCap-specific configured radio frequency retune gap,
wherein separate RACH occasion resources are configured in separate eRedCap-specific initial uplink bandwidth parts.

17. The UE of claim 11, wherein the first bandwidth part and the second bandwidth part are separately configured via at least one of:
radio resource control (RRC) configuration, or
the eRedCap-specific system information.

18. The UE of claim 17, wherein the first bandwidth part is an initial downlink bandwidth part, and the second bandwidth part is an initial uplink bandwidth part.

19. The UE of claim 17, wherein the one or more processors, to separate configurations for the first bandwidth part and the second bandwidth part may, are configured to:
a time division duplex configuration, or
a frequency division duplex configuration.

20. The UE of claim 1, wherein the UE is an eRedCap UE.

21. The UE of claim 1, wherein the SSB is a cell-defining SSB.

22. A network node for wireless communication, comprising:
a memory; and
one or more processors, coupled to the memory, configured to:
transmit a synchronization signal block (SSB) indicating an enhanced reduced capability (eRedCap)-specific control resource set (CORESET) that is separate from another CORESET indicated by the SSB; and
transmit eRedCap-specific system information using the eRedCap-specific CORESET.

23. The network node of claim 22, wherein the eRedCap-specific system information is included in eRedCap-specific system information blocks (SIBs).

24. The network node of claim 22, wherein the eRedCap-specific system information is included in system information blocks (SIBs) that are not eRedCap-specific.

25. The network node of claim 24, wherein the SIBs include at least one eRedCap-specific parameter.

26. The network node of claim 22, wherein the eRedCap-specific system information indicates an eRedCap-specific resource that includes at least one of:
an eRedCap-specific initial downlink bandwidth part,
an eRedCap-specific initial uplink bandwidth part, or
an eRedCap-specific common search space for the eRedCap-specific system information, paging, and random access communications.

27. The network node of claim 22, wherein the one or more processors are further configured to:
perform a random access channel (RACH) procedure using an eRedCap-specific initial downlink bandwidth part.

28. The network node of claim 22, wherein the SSB includes a system information parameter that maps to the eRedCap-specific CORESET.

29. A method of wireless communication performed by an apparatus of a user equipment (UE), comprising:
receiving, from a network node, a synchronization signal block (SSB) indicating an enhanced reduced capability (eRedCap)-specific control resource set (CORESET) that is separate from another CORESET indicated by the SSB; and
receiving, from the network node, eRedCap-specific system information from the eRedCap-specific CORESET.

30. A method of wireless communication performed by a network node, comprising:
transmitting a synchronization signal block (SSB) indicating an enhanced reduced capability (eRedCap)-specific control resource set (CORESET) that is separate from another CORESET indicated by the SSB; and
transmitting eRedCap-specific system information using the eRedCap-specific CORESET.
